(19) United States
(12) Patent Application Publication
(10) Pub. No.: US 2026/0093040 A1
(43) Pub. Date: Apr. 2, 2026

(54) AUGMENTED AND MULTIPLE LIDAR-BASED SCINTILLOMETERS

(71) Applicant: The United States of America, as represented by the Secretary of the Navy, Crane, IN (US)

(72) Inventor: Joseph Anthony Fiordilino, Corona, CA (US)

(73) Assignee: The United States of America, as represented by the Secretary of the Navy, Arlington, VA (US)

(21) Appl. No.: 19/344,723

(22) Filed: Sep. 30, 2025

Related U.S. Application Data
(60) Provisional application No. 63/701,189, filed on Sep. 30, 2024.

(51) Int. Cl. G01S 17/95; G01S 7/481

(52) U.S. Cl. CPC G01S 17/95; G01S 7/4814; G01S 7/4816

(57) ABSTRACT

Provided is a LIDAR-based scintillometer. The LIDAR system propagates outwards into the atmosphere and a backscattered signal is collected by a telescope. The signal is passed through a series of optical elements into a detector. One or more spectral filters isolate backscattered wavelengths bands of interest corresponding to excited atmospheric constituents. The signal is then amplified and photon counts are collected and analyzed. The inventive device is capable of measuring temperature fluctuations in atmosphere and converting the fluctuations into Kolmogorov-based refractive index structure coefficients that are useful in atmospheric propagation of electromagnetic radiation. The modification or combination of existing LIDAR systems with scintillometers allows for multiple, closely spaced temperature differences to be calculated and, thus, refractive index structure coefficient measurements.

### CROSS-REFERENCE TO RELATED APPLICATIONS

The present application claims priority to U.S. Provisional Patent Application Ser. No. 63/701,189, filed Sep. 30, 2024, entitled “AUGMENTED AND MULTIPLE LIDAR-BASED SCINTILLOMETERS,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 211866) is assigned to the United States Government and is available for licensing for commercial purposes. Licensing and technical inquiries may be directed to the Technology Transfer Office, Naval Surface Warfare Center Corona, email: CRNA_CTO@navy.mil.

### FIELD OF THE INVENTION

The field of invention relates generally to scintillometers. More particularly, it pertains to a LIDAR-based scintillometer capable of measuring temperature fluctuations in the atmosphere.

### BACKGROUND

Scintillometers are devices which fundamentally detect variations of intensity of electromagnetic radiation. Typically, these devices involve transmitter-receiver pairs whereby electromagnetic radiation is propagated towards a receiver, which detects the scintillation induced on the propagated radiation due to fluctuations in the index of refraction of the propagation medium. The first prototype research systems were developed and tested in the 1970s. Since then, there have been a variety of devices developed and available commercially. Moreover, there are also university owned and government funded systems.

Commercial devices that are known and in use include the MZA DELTA and the PROPS atmospheric profilers, which are both dual ended systems requiring a transmitter source and receiver. The DELTA is an LED based system, whereas the PROPS models are both LED and laser based at infrared wavelengths. In the PROPS, two transmitter-receiver pairs are placed opposite to one another with available measurement ranges of between 0.5-50 km. The power demands of these systems typically range between 100-950 W, but can reach 3600 W.

Other commercial systems, such as the Scintec BLS and SLS models both involve transmitter and receiver pairs, whereby BLS systems involve arrays of infrared and visible LEDs, yielding 0.1-12 km range, and the SLS models involve optical wavelength lasers, with 0.05-0.25 km range. Lastly, Kipp & Zonen's LAS MkII utilizes an 850 nm source with 0.1-12 km range. Each of the abovementioned devices has nuances that differentiates them from one another. These latter three devices have relatively low power draw, ranging between 1.3 and 54 W.

The Integrated Atmospheric Characterization System (IACS) developed by Georgia Tech Research Institute comprises three LIDARs operating at 355 nm, 1.06 μm, and 1.627 μm. The three LIDARs measure aerosol extinction, refractive index structure coefficient (Cn2), and water vapor profile, among other derived quantities. The system is quite large and power hungry. The system provides Cn2 measurements every 0.25 km up to 7 km below an altitude of 1 km.

Recent years have seen significant expansion of applications of LIDAR systems, including for scintillometry. The primary advantage of LIDAR-based systems is a lack of beacon requirement; i.e., the system is single-ended. However, this comes at the cost of elevated size, weight, and power requirements, especially for Raman-based systems, relative to dual-ended systems. A variety of LIDAR techniques are utilized for atmospheric measurements, e.g., Raman, differential absorption LIDAR (DIAL), high spectral resolution LIDAR (HSRL), Doppler, and combinations of these; the various techniques have strengths and weaknesses that lend themselves to measurements of atmospheric quantities, e.g., wind velocity, temperature, and water vapor.

For Raman types, the typical multi-wavelength configuration involves an Nd:YAG laser emitting 355, 532, and 1064 nm beams. The elastically backscattered signals at these wavelengths are collected as well as vibration-rotation signals of both water vapor (H₂O) and Nitrogen (N₂) and both parallel- and cross-polarized components of the frequency doubled signal. This type of system is typically denoted as 3β+2α Raman LIDAR; corresponding to three backscatter and two extinction recorded signals.

### SUMMARY OF THE INVENTION

The present invention relates to a LIDAR-based scintillometer. The LIDAR system propagates outwards into atmosphere and a backscattered signal is collected by a telescope. The signal is passed through a series of optical elements into a detector. One or more spectral filters isolate backscattered wavelengths bands of interest corresponding to excited atmospheric constituents. The signal is then amplified and photon counts are collected and analyzed. The inventive device is capable of measuring temperature fluctuations in atmosphere and converting the fluctuations into Kolmogorov-based refractive index structure coefficients that are useful in atmospheric propagation of electromagnetic radiation. The modification or combination of existing LIDAR systems with scintillometers allows for multiple, closely spaced temperature differences to be calculated and, thus, refractive index structure coefficient measurements.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying Figures in which:

FIG. 1 shows an illustration of a Raman LIDAR instrument.

FIG. 2 shows an illustration of LIDAR laser propagation through a 1:3 DOE.

FIG. 3 shows an illustration of geometry involved with a 1:2 DOE.

FIG. 4 shows an illustration of LIDAR laser propagation with multiple beams.

FIG. 5 shows an illustration of LIDAR laser propagation through a transmissive spiral phase plate.

FIG. 6 shows an illustration of quadrant-centric center of mass involved with a Laguerre-Gaussian beam.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

Provided is a LIDAR-based scintillometer comprising: a laser source; one or more turning mirrors; a telescope; a collimating lens; one or more spectral filters; a detector; and a processor; wherein a beam is generated from the laser source, propagates outwards into atmosphere, and a backscattered signal is collected by the telescope; wherein the backscattered signals are fed through the collimating lens, the one or more spectral filters and the detector; wherein the spectral filters isolate backscattered wavelength bands of interest corresponding to excited atmospheric constituents; wherein the backscattered signal is amplified and photon counts are collected to detect variations of intensity of atmospheric electromagnetic radiation; wherein the detected variations of intensity of atmospheric electromagnetic radiation are converted into local temperature variations and a measure of optical turbulence.

In an illustrative embodiment, the one or more laser sources is a Nd:YAG. In an illustrative embodiment, the telescope is a Schmidt-Cassegrain telescope. In an illustrative embodiment, the detector is a photomultiplier tube. In an illustrative embodiment, the LIDAR-based scintillometer further comprises a diffractive optical element beam splitter. In an illustrative embodiment, the diffractive optical element beam splitter generates/beams, wherein each beam is initially separated by a distance, dJ, and angle, θJ, from normal to the diffractive optical element beam splitter. In an illustrative embodiment, a separation distance, r, between separated beams is calculated after redirecting or straightening the beams a distance l′ away from the diffractive optical element beam splitter using

r=d_{J}+2l′ tan θ_{J}.

In an illustrative embodiment, backscattered signals are fed through a quadrant photomultiplier, spectral filters, and collimating lens. In an illustrative embodiment, the laser beam passes through a transmissive spiral phase plate. In an illustrative embodiment, the transmissive spiral phase plate converts a Gaussian source beam into a Laguerre-Gaussian (LG) or vortex beam.

In an illustrative embodiment, provided is a LIDAR-based scintillometer comprising: a single laser source; a diffractive optical element beam splitter; one or more turning mirrors; a telescope; a collimating lens; one or more spectral filters; a detector; and a processor; wherein the diffractive optical element beam splitter generates/beams from the single laser source; wherein each beam is initially separated from a neighboring beam by a distance, dJ, and angle, θJ, from normal to the diffractive optical element beam splitter; wherein each of the/beams propagates outwards into atmosphere and a backscattered signal is collected by the telescope; wherein the backscattered signals are fed through the collimating lens, the spectral filters and the detector; wherein the spectral filters isolate backscattered wavelength bands of interest corresponding to excited atmospheric constituents; wherein the backscattered signal is amplified and photon counts are collected to detect variations of intensity of atmospheric electromagnetic radiation; wherein the detected variations of intensity of atmospheric electromagnetic radiation are converted into local temperature variations and a measure of optical turbulence.

In an illustrative embodiment, provided is a LIDAR-based scintillometer comprising: a single laser source; a transmissive or reflective spiral phase plate; one or more turning mirrors; a telescope; a collimating lens; one or more spectral filters; a detector; and a processor; wherein the spiral phase plate generates a single vortex beam from the single laser source; wherein the beam propagates outwards into atmosphere and a backscattered signal is collected by the telescope; wherein the backscattered signals are fed through the collimating lens, the spectral filters and the detector; wherein the spectral filters isolate backscattered wavelength bands of interest corresponding to excited atmospheric constituents; wherein the backscattered signal is amplified and photon counts are collected to detect quadrant-based variations of intensity of atmospheric electromagnetic radiation; wherein the detected variations of intensity of atmospheric electromagnetic radiation are converted into local temperature variations and a measure of optical turbulence.

In an illustrative embodiment, provided is a LIDAR-based scintillometer comprising: two laser sources; one or more turning mirrors; a telescope; a collimating lens; one or more spectral filters; a detector; and a processor; wherein the laser sources propagate two laser beams spaced by apart by distance, d; wherein the beams propagate outwards into atmosphere and a backscattered signal is collected by the telescope; wherein the backscattered signals are fed through the collimating lens, the spectral filters and the detector; wherein the spectral filters isolate backscattered wavelength bands of interest corresponding to excited atmospheric constituents; wherein the backscattered signals are amplified and photon counts are collected to detect variations of intensity of atmospheric electromagnetic radiation; wherein the detected variations of intensity of atmospheric electromagnetic radiation are converted into local temperature variations and a measure of optical turbulence.

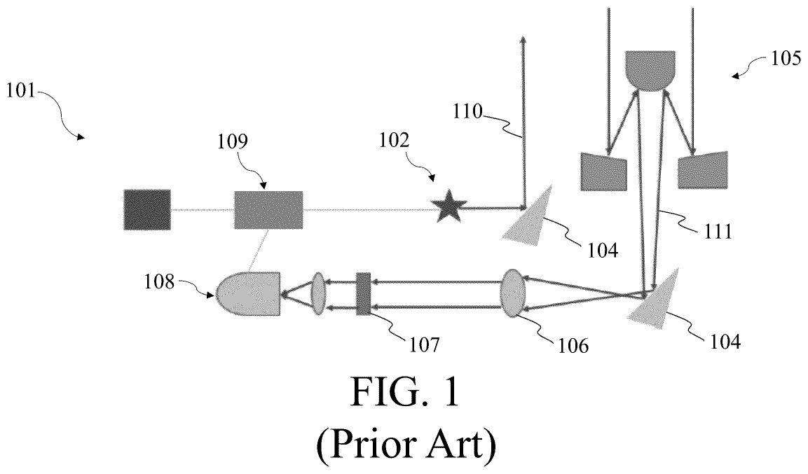

FIG. 1 depicts an exemplary embodiment of a prior art Raman LIDAR system 101. In an illustrative embodiment, the LIDAR-based scintillometer 101 comprises a laser source 102, one or more turning mirrors 104; a telescope 105; a collimating lens 106; one or more spectral filters 107; a detector 108; and a processor 109. As is known, a Raman LIDAR system is a light detection and ranging (LIDAR) instrument that uses laser to measure atmospheric or material properties by detecting the inelastic Raman scattering of light by molecules. Raman LIDAR provides additional wavelengths compared with other LIDAR instruments, allowing for the measurement of water vapor, aerosols, temperature, ozone, and other substances such as oil or plastics in water.

The Raman LIDAR system transmits a laser beam 110 from the ground into the atmosphere or towards a target. As the laser beam 110 interacts with atmospheric molecules (i.e., H₂O and N₂), it undergoes Raman scattering (or backscattering) and gains or loses energy. A receiver telescope 105 collects the backscattered light 111, including signals at different wavelengths resulting from Raman scattering. The backscattered light 111 travels from the telescope 105 through a collimating lens 106 and one or more spectral filters 107 to a detector 108 and processor 109. Analysis is done by the processor 109 to analyze the intensity and wavelength of the Raman signals, which in turn provides data related to the concentration of specific atmospheric gases or the molecular composition of materials.

In an illustrative embodiment, the inventive LIDAR-based scintillometer comprises one or more laser sources 102; one or more turning mirrors 104; a telescope 105; a collimating lens 106; one or more spectral filters 107; a detector 108; and a processor 109. In an illustrative embodiment, the laser source 102 (in this non-limiting embodiment, a Nd:YAG), propagates outwards into the atmosphere, wherein a backscattered signal is collected by a compact telescope 105 (in this non-limiting embodiment, a Schmidt-Cassegrain telescope), and passes through a series of optical elements (in this non-limiting embodiment, a collimating lens 106 and one or more spectral filters 107) into a detector 108 (in this non-limiting embodiment, a photomultiplier tube). Spectral filters 107 are chosen to isolate backscattered wavelengths bands of interest corresponding to excited atmospheric constituents, (i.e., H₂O and N₂). The signal is amplified and photon counts are collected and fed into the processor 109 for analysis. In an illustrative embodiment, a 3β+2α Raman LIDAR system, and/or a DIAL/HSRL combination can also be utilized. Depending on the laser source, either Raman or Rayleigh scattering modalities can be used.

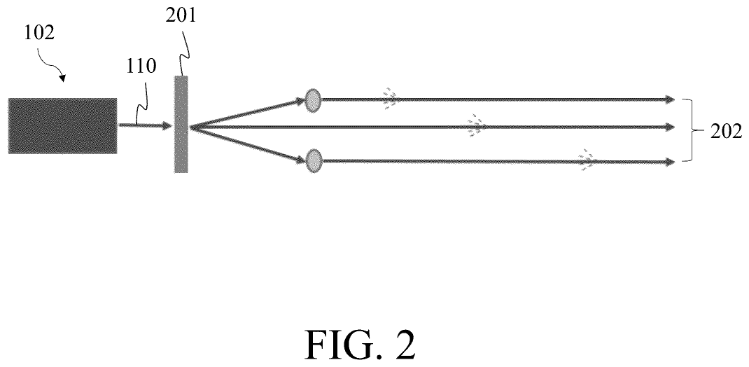

FIG. 2 shows an illustration of LIDAR laser propagation through a 1:3 DOE. In an illustrative embodiment, the laser beam 110 travels from the laser source 102 and passes through a diffractive optical element (DOE) beam splitter 201, which efficiently splits the outgoing laser beam 110 into multiple beams. Shown in FIG. 2 is a 1:3 DOE beam splitter 201 that splits the laser beam 110 into three beams 202 (e.g., a 1:2 or 1:3 DOE).

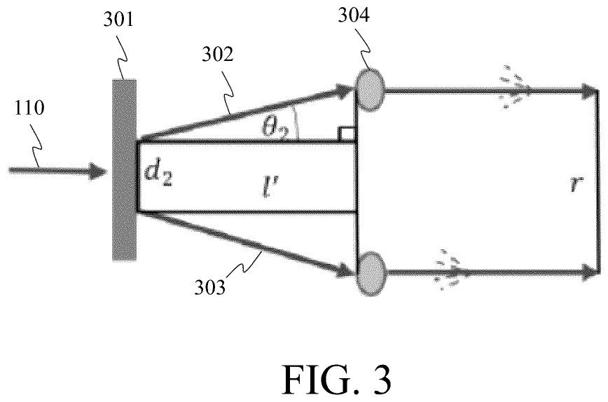

FIG. 3 shows an illustration of geometry involved with a 1:2 DOE 301. In an illustrative embodiment, the DOE 301 generates/beams (in this non-limiting example, two beams 302, 303) from a laser beam 110, wherein each beam 302, 303 is initially separated by a distance, dJ, and angle, θJ, from the normal to the DOE 301. In an illustrative embodiment, efficiency gains (redirecting and/or straightening) can be made through customized elements or refractive optical elements (such as turning mirrors 304). The separation distance, r, between beams 302, 303 can be calculated after redirecting or straightening the beams a distance l′ away from the DOE 301 using the following formula:

$$r = {d}_{j} + 2 {l}^{′} tan {θ}_{j} .$$

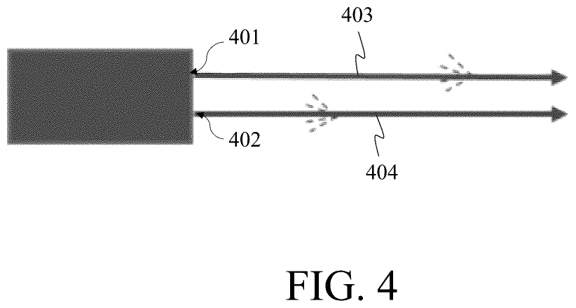

FIG. 4 shows an illustration of LIDAR laser propagation with multiple beams. In an illustrative embodiment, the inventive LIDAR-based scintillometer comprises multiple laser sources that produce multiple laser beams. In an illustrative embodiment, the inventive LIDAR-based scintillometer can comprise two laser sources 401, 402 that produce two laser beams 403, 404. In an illustrative embodiment, the inventive LIDAR-based scintillometer can comprise additional LIDARs or secondary signals with offset frequency modulation; wherein signal separation distances will be smaller. In an illustrative embodiment, the inventive LIDAR-based scintillometer can comprise LIDAR optics that are combined (as illustrated in FIG. 4) or closely placed.

In an illustrative embodiment, backscattered signals are fed through a modified detector, (in a non-limiting embodiment, a quadrant photomultiplier (PMT)), associated spectral filters, and collimating lens within the LIDAR optics subsystem. As can be appreciated, internal optics must straighten the backscattered signal onto the appropriate quadrants of the quadrant PMT (i.e., two, three, or four). In an illustrative embodiment, the quadrant PMT can be used to replace beam splitters found in conventional LIDAR systems. In an illustrative embodiment, for near IR (NIR) signals, signal sensitivity can be increased via an up-conversion technique, which has shown ˜9× signal for a 1.064 μm-based atmospheric aerosol LIDAR.

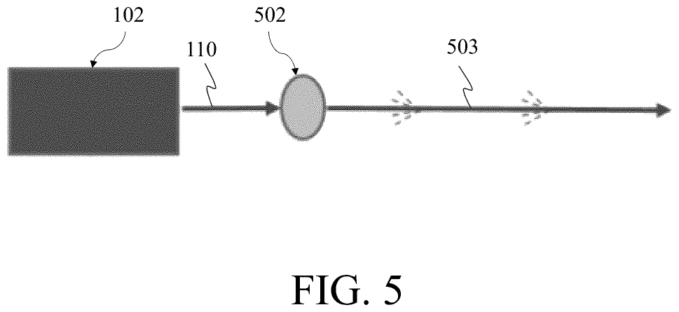

FIG. 5 shows an illustration of LIDAR laser propagation through a transmissive spiral phase plate 501. In an illustrative embodiment, the inventive LIDAR-based scintillometer passes the laser beam 110 through a transmissive spiral phase plate 502. The SPP converts a Gaussian source beam into a Laguerre-Gaussian (LG) or vortex beam 503. In the case of an azimuthal order one LG beam of radius R, the centers of mass, in each quadrant i, corresponds to

$${\{ ( {x}_{c} {y}_{c} ) \}}_{1 \leq i \leq 4} = \{ ( \frac{2 R}{π} , \frac{2 R}{π} ) , ( - \frac{2 R}{π} , \frac{2 R}{π} ) , ( - \frac{2 R}{π} , - \frac{2 R}{π} ) , ( \frac{2 R}{π} , - \frac{2 R}{π} ) \} .$$

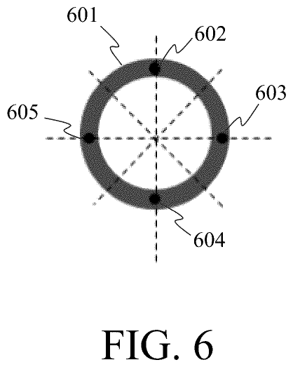

FIG. 6 shows an illustration of quadrant-centric center of mass involved with a Laguerre-Gaussian beam 601. In an illustrative embodiment, similar to the DOE implementation, a quadrant PMT can be used in conjunction with appropriate optical elements to receive the signals from each quarter ring of the backscattered signal. In an illustrative embodiment, four measurements 602-605 can be generated at the points of intersection between a centered Cartesian plane and the intensity profile; as shown in FIG. 6. This is equivalent to the center of mass in a 45° counter-clockwise rotated coordinate frame.

It should be noted that the intensity profile does not fully characterize a LG beam. Indeed, the helical structure implies there is a spatial difference, proportional to λ, along the propagation direction of the phase front. However, this is not a paralyzing limitation since the Kolmogorov microscale is three or more orders of magnitude larger than typical LIDAR wavelengths.

In an illustrative embodiment, four selected points 602-605 can be used to estimate distinct atmospheric temperatures or can be used to calculate an average temperature at the center of mass of the convex hull. In the former, the four measurements allow for six differential temperature calculations, associated with the midpoint between them. As can be appreciated, these calculations each correlate to a center of mass within a quadrant in a suitable frame of reference. Analogously, in the DOE implementation, each of the generated beams can provide a distinct temperature measurement and, thus, be used to calculate temperature differentials.

$${C}_{T}^{2} = \frac{\overline{Δ {T}^{2}}}{{r}^{\frac{2}{3}}} .$$

wherein ⋅̅ denotes an ensemble average and ΔT is the temperature difference between two spatial points separated by a distance r. In an illustrative embodiment, application assumptions presume homogeneous and isotropic turbulence within the inertial subrange. From the above, one can calculate the refractive index structure coefficient via,

$${C}_{n}^{2} = {[ \frac{79 P}{{T}^{2}} \times {10}^{- 6} ]}^{2} {C}_{T}^{2} ,$$

where p and T are the local barometric pressure and temperature, in mbar and Kelvin units, respectively. The local barometric pressure can be captured via an integrated barometer or weather station (e.g., Davis Vantage Pro2); local temperature can be provided by one of the LIDAR-based temperature measurements or an integrated sensor.

In an illustrative embodiment, the inventive LIDAR-based scintillometer allows for modification or combination of existing LIDAR systems for producing temperature measurements. The modifications allow for multiple, closely spaced (e.g., vertically or horizontally), temperature differences to be calculated and, thus, refractive index structure coefficient measurements. Consequently, the spatial resolution is dramatically increased and, moreover, range is improved by utilizing both averaging and up-conversion and leveraging increased propagation performance of LG beams over classical Gaussian beam propagation

Although the invention has been described in detail with reference to certain preferred embodiments, variations and modifications exist within the spirit and scope of the invention as described and defined in the following claims.

1. A LIDAR-based scintillometer comprising:
a laser source;
one or more turning mirrors;
a telescope;
a collimating lens;
one or more spectral filters;
a detector; and
a processor;
wherein a beam is generated from said laser source, propagates outwards into atmosphere, and a backscattered signal is collected by said telescope;
wherein said backscattered signals are fed through said collimating lens, said one or more spectral filters and said detector;
wherein said spectral filters isolate backscattered wavelength bands of interest corresponding to excited atmospheric constituents;
wherein said backscattered signal is amplified and photon counts are collected to detect variations of intensity of atmospheric electromagnetic radiation;
wherein said detected variations of intensity of atmospheric electromagnetic radiation are converted into local temperature variations and a measure of optical turbulence.

2. The LIDAR-based scintillometer of claim 1, wherein said one or more laser sources is a Nd:YAG.

3. The LIDAR-based scintillometer of claim 1, wherein said telescope is a Schmidt-Cassegrain telescope.

4. The LIDAR-based scintillometer of claim 1, wherein said detector is a photomultiplier tube.

5. The LIDAR-based scintillometer of claim 1, further comprising a diffractive optical element beam splitter.

6. The LIDAR-based scintillometer of claim 5, wherein said diffractive optical element beam splitter generates/beams, wherein each beam is initially separated by a distance, dJ, and angle, θJ, from normal to said diffractive optical element beam splitter.

7. The LIDAR-based scintillometer of claim 6, wherein a separation distance, r, between separated beams is calculated after redirecting or straightening said beams a distance l′ away from said diffractive optical element beam splitter using:
$$r = {d}_{f} + 2 {l}^{′} tan {θ}_{j} .$$

8. The LIDAR-based scintillometer of claim 1, wherein backscattered signals are fed through a quadrant photomultiplier, spectral filters, and collimating lens.

9. The LIDAR-based scintillometer of claim 1, wherein said laser beam passes through a transmissive spiral phase plate.

10. The LIDAR-based scintillometer of claim 9, wherein said transmissive spiral phase plate converts a Gaussian source beam into a Laguerre-Gaussian (LG) or vortex beam.

11. A LIDAR-based scintillometer comprising:
a single laser source;
a diffractive optical element beam splitter;
one or more turning mirrors;
a telescope;
a collimating lens;
one or more spectral filters;
a detector; and
a processor;
wherein said diffractive optical element beam splitter generates/beams from said single laser source;
wherein each beam is initially separated from a neighboring beam by a distance, dJ, and angle, θJ, from normal to said diffractive optical element beam splitter;
wherein each of said/beams propagates outwards into atmosphere and a backscattered signal is collected by said telescope;
wherein said backscattered signals are fed through said collimating lens, said spectral filters and said detector;
wherein said spectral filters isolate backscattered wavelength bands of interest corresponding to excited atmospheric constituents;
wherein said backscattered signal is amplified and photon counts are collected to detect variations of intensity of atmospheric electromagnetic radiation;
wherein said detected variations of intensity of atmospheric electromagnetic radiation are converted into local temperature variations and a measure of optical turbulence.

12. The LIDAR-based scintillometer of claim 11, wherein said one or more laser sources is a Nd:YAG.

13. The LIDAR-based scintillometer of claim 11, wherein said telescope is a Schmidt-Cassegrain telescope.

14. The LIDAR-based scintillometer of claim 11, wherein said detector is a photomultiplier tube.

15. The LIDAR-based scintillometer of claim 11, further comprising a diffractive optical element beam splitter.

16. The LIDAR-based scintillometer of claim 15, wherein said diffractive optical element beam splitter generates/beams, wherein each beam is initially separated by a distance, dJ, and angle, θJ, from normal to said diffractive optical element beam splitter.

17. The LIDAR-based scintillometer of claim 16, wherein a separation distance, r, between separated beams is calculated after redirecting or straightening said beams a distance l′ away from said diffractive optical element beam splitter using
$$r = {d}_{j} + 2 {l}^{′} tan {θ}_{j} .$$

18. The LIDAR-based scintillometer of claim 11, wherein backscattered signals are fed through a quadrant photomultiplier, spectral filters, and collimating lens.

19. The LIDAR-based scintillometer of claim 11, wherein said laser beam passes through a transmissive spiral phase plate.

20. The LIDAR-based scintillometer of claim 19, wherein said transmissive spiral phase plate converts a Gaussian source beam into a Laguerre-Gaussian (LG) or vortex beam.

21. A LIDAR-based scintillometer comprising:
a single laser source;
a transmissive or reflective spiral phase plate;
one or more turning mirrors;
a telescope;
a collimating lens;
one or more spectral filters;
a detector; and
a processor;
wherein said spiral phase plate generates a single vortex beam from said single laser source;
wherein said beam propagates outwards into atmosphere and a backscattered signal is collected by said telescope;
wherein said backscattered signals are fed through said collimating lens, said spectral filters and said detector;
wherein said spectral filters isolate backscattered wavelength bands of interest corresponding to excited atmospheric constituents;
wherein said backscattered signal is amplified and photon counts are collected to detect quadrant-based variations of intensity of atmospheric electromagnetic radiation;
wherein said detected variations of intensity of atmospheric electromagnetic radiation are converted into local temperature variations and a measure of optical turbulence.

22. The LIDAR-based scintillometer of claim 21, wherein said one or more laser sources is a Nd:YAG.

23. The LIDAR-based scintillometer of claim 21, wherein said telescope is a Schmidt-Cassegrain telescope.

24. The LIDAR-based scintillometer of claim 21, wherein said detector is a photomultiplier tube.

25. The LIDAR-based scintillometer of claim 21, further comprising a diffractive optical element beam splitter.

26. The LIDAR-based scintillometer of claim 25, wherein said diffractive optical element beam splitter generates/beams, wherein each beam is initially separated by a distance, dJ, and angle, θJ, from normal to said diffractive optical element beam splitter.

27. The LIDAR-based scintillometer of claim 26, wherein a separation distance, r, between separated beams is calculated after redirecting or straightening said beams a distance l′ away from said diffractive optical element beam splitter using
$$r = {d}_{j} + 2 {l}^{′} tan {θ}_{j} .$$

28. The LIDAR-based scintillometer of claim 21, wherein backscattered signals are fed through a quadrant photomultiplier, spectral filters, and collimating lens.

29. The LIDAR-based scintillometer of claim 21, wherein said laser beam passes through a transmissive spiral phase plate.

30. The LIDAR-based scintillometer of claim 29, wherein said transmissive spiral phase plate converts a Gaussian source beam into a Laguerre-Gaussian (LG) or vortex beam.

31. A LIDAR-based scintillometer comprising:
two laser sources;
one or more turning mirrors;
a telescope;
a collimating lens;
one or more spectral filters;
a detector; and
a processor;
wherein said laser sources propagate two laser beams spaced by apart by distance, d;
wherein said beams propagate outwards into atmosphere and a backscattered signal is collected by said telescope;
wherein said backscattered signals are fed through said collimating lens, said spectral filters and said detector;
wherein said spectral filters isolate backscattered wavelength bands of interest corresponding to excited atmospheric constituents;
wherein said backscattered signals are amplified and photon counts are collected to detect variations of intensity of atmospheric electromagnetic radiation;
wherein said detected variations of intensity of atmospheric electromagnetic radiation are converted into local temperature variations and a measure of optical turbulence.

32. The LIDAR-based scintillometer of claim 31, wherein said one or more laser sources is a Nd:YAG.

33. The LIDAR-based scintillometer of claim 31, wherein said telescope is a Schmidt-Cassegrain telescope.

34. The LIDAR-based scintillometer of claim 31, wherein said detector is a photomultiplier tube.

35. The LIDAR-based scintillometer of claim 31, further comprising a diffractive optical element beam splitter.

36. The LIDAR-based scintillometer of claim 35, wherein said diffractive optical element beam splitter generates/beams, wherein each beam is initially separated by a distance, dJ, and angle, θJ, from normal to said diffractive optical element beam splitter.

37. The LIDAR-based scintillometer of claim 36, wherein a separation distance, r, between separated beams is calculated after redirecting or straightening said beams a distance l′ away from said diffractive optical element beam splitter using
$$r = {d}_{j} + 2 {l}^{′} tan {θ}_{j} .$$

38. The LIDAR-based scintillometer of claim 31, wherein backscattered signals are fed through a quadrant photomultiplier, spectral filters, and collimating lens.

39. The LIDAR-based scintillometer of claim 31, wherein said laser beam passes through a transmissive spiral phase plate.

40. The LIDAR-based scintillometer of claim 39, wherein said transmissive spiral phase plate converts a Gaussian source beam into a Laguerre-Gaussian (LG) or vortex beam.
